(19) United States
(12) Patent Application Publication
(10) Pub. No.: US 2026/0367492 A1
(43) Pub. Date: Nov. 19, 2026

(54) PROJECTOR

(71) Applicant: Coretronic Corporation, Hsin-Chu (TW)

(72) Inventor: Chang-Yung Chen, Hsin-Chu (TW)

(73) Assignee: Coretronic Corporation, Hsin-Chu (TW)

(21) Appl. No.: 19/661,643

(22) Filed: Apr. 28, 2026

(30) Foreign Application Priority Data
May 13, 2025 (CN) 202510610368.8

(51) Int. Cl. G03B 21/14

(52) U.S. Cl. CPC G03B 21/145

(57) ABSTRACT

A projector including a housing and at least one adjusting device. The housing includes a bottom surface. The at least one adjusting device is disposed in the housing, and the at least one adjusting device includes a first gear, a stud, and a stopper. The first gear has a through hole. The stud is engaged with the through hole. The stopper has a limiting structure and a limiting hole, wherein the first gear is located between the limiting hole and the bottom surface. The limiting hole has two grooves, and the stud penetrates through the limiting hole. The projector having the at least one adjustment device allows for smooth adjustment of the height between the projector and a table surface.

### CROSS-REFERENCE TO RELATED APPLICATION

This application claims the priority benefit of China application serial no. 202510610368.8, filed on May 13, 2025. The entirety of the above-mentioned patent application is hereby incorporated by reference herein and made a part of this specification.

### BACKGROUND

### Technical Field

The disclosure relates to a projector having an adjusting device. A height of the projector is adjusted by the adjusting device to change a position of an image projected by the projector.

### Description of Related Art

Currently, when using a projector, the height between the projector and the table surface needs to be adjusted due to the position of the projection screen and the distance between the projection screen and the projector, so that the image projected by the projector can be completely presented on the projection screen.

In general, an adjusting device is provided with a gear and a stud, wherein the stud penetrates the gear and the gear rotates relative to the stud. In order to prevent the stud from being driven to rotate together with the gear when the gear rotates, a stopper is disposed beside the stud to limit the rotation of the stud. However, when the adjusting device is rotated, the external force generated by the rotation of the gear easily causes the stud to tilt, resulting in the gear being unable to rotate. In addition, the stud and the stopper are both metal. When the stud is rotated relative to the stopper due to the rotation of the gear, the stud pushes against the stopper, resulting in damage to the threads of the stud or the threads being jammed into the stopper, which causes the adjusting device to fail to operate.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides a projector having an adjusting device, which allows a height of the projector to be adjusted smoothly.

Other objects and advantages of the disclosure can be further understood from the technical features disclosed herein.

To achieve one or part or all of the above objects or other objects, a projector of the disclosure includes a housing and at least one adjusting device. The housing includes a bottom surface. The at least one adjusting device is disposed in the housing, and the at least one adjusting device includes a first gear, a stud, and a stopper. The first gear has a through hole. The stud is engaged with the through hole. The stopper has a limiting structure and a limiting hole. The first gear is located between the limiting hole and the bottom surface. The limiting hole has two grooves, and the stud penetrates the limiting hole.

Based on the above, the stopper of the adjusting device of the projector of the disclosure has a limiting hole, and the stud penetrates the limiting hole such that the stud is fixed in the limiting hole. Therefore, when the first gear rotates, the stud does not tilt, which would otherwise prevent the adjusting device from operating. In addition, the limiting hole has two grooves, such that when the stud is rotated in the limiting hole by the rotation of the first gear, the stud is not jammed in the stopper. The problem that the stud and the stopper are jammed with each other and thereby the height of the projector cannot be adjusted can be effectively solved.

To make the features and advantages of the disclosure more comprehensible, several embodiments accompanied with drawings are described in detail as follows.

### BRIEF DESCRIPTION OF THE DRAWINGS

FIG. 1A is a schematic view of a projector according to the disclosure.

FIG. 1B is a partially enlarged view of FIG. 1A.

FIG. 1C is an exploded view of FIG. 1B.

FIG. 1D is a top schematic view of FIG. 1B.

FIG. 1E is a side schematic view of FIG. 1B.

FIG. 2A is a schematic view of a projector according to another embodiment of the disclosure.

FIG. 2B is a partially enlarged view of FIG. 2A.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as "top," "bottom," "front," "back," etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

The above and other technical contents, features, and effects of the disclosure can be clearly presented in the following detailed description of one preferred embodiment in conjunction with the accompanying drawings. The directional terms mentioned in the following embodiment, such as up, down, left, right, front, or rear, are only based on the directions of the accompanying drawings. Therefore, the directional terms used are for illustration and not to limit the disclosure.

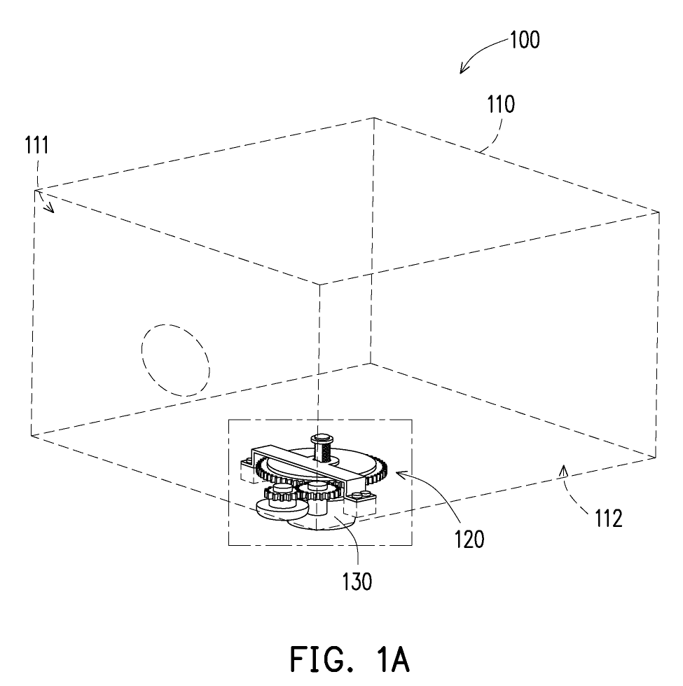

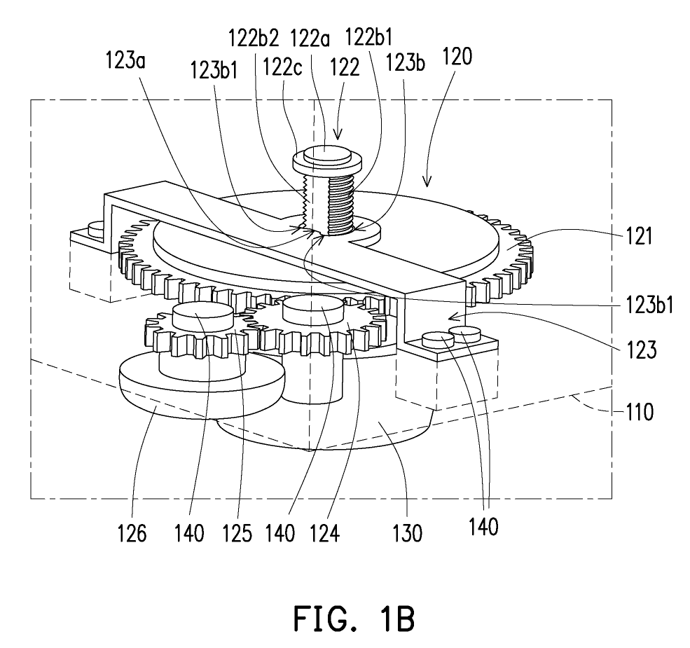

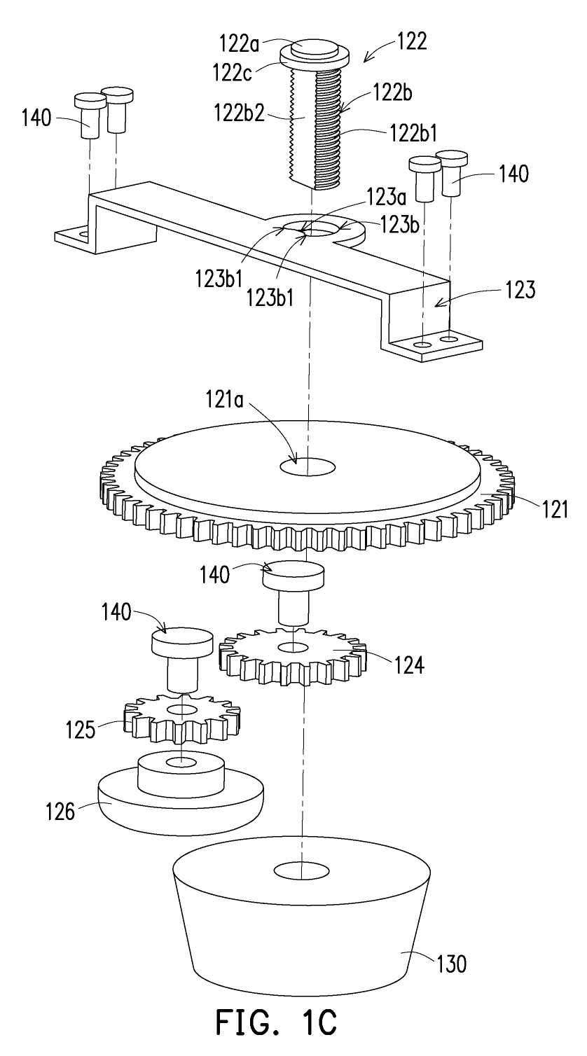

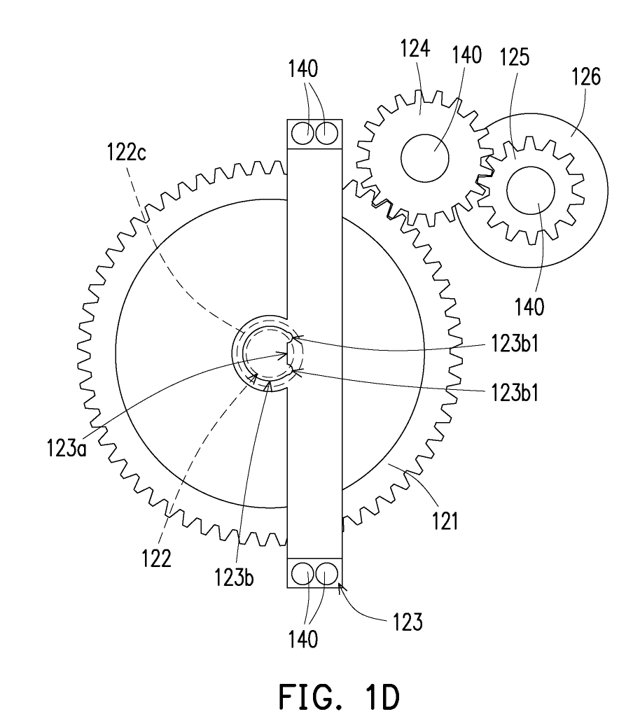

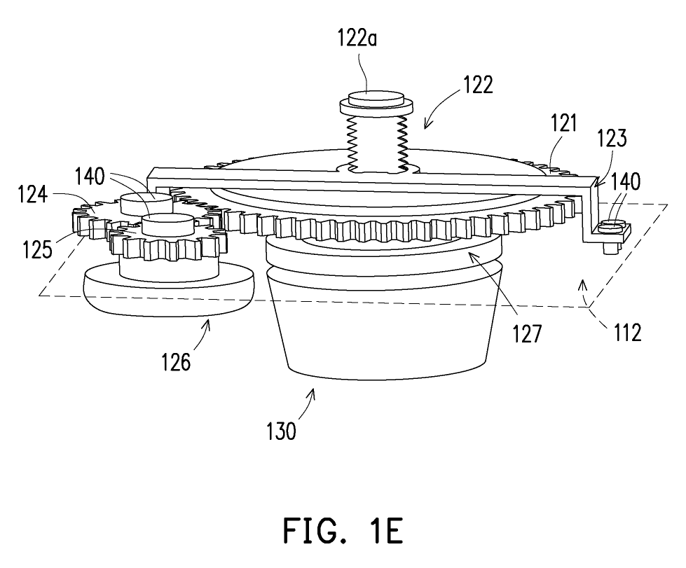

FIG. 1A is a schematic view of a projector according to the disclosure. FIG. 1B is a partially enlarged view of FIG. 1A. FIG. 1C is an exploded view of FIG. 1B. FIG. 1D is a top schematic view of FIG. 1B. FIG. 1E is a side schematic view of FIG. 1B. Referring to FIGS. 1A, 1B, 1C, 1D, and 1E, a projector 100 of the disclosure includes a housing 110 and at least one adjusting device 120. The housing 110 includes at least one side surface 111 and a bottom surface 112. The side surface 111 has an opening (dashed circle in the figure), allowing a part of the projection lens to be exposed from the housing 110 through the opening. Or, the opening of the side surface 111 only allows a light beam to pass through. The at least one adjusting device 120 is fixed to the bottom surface 112. In an embodiment, the projector 100 may have a single adjusting device 120 disposed on the bottom surface 112 of the projector 100. In other embodiments, the projector 100 may have two adjusting devices 120, respectively disposed at two positions on the bottom surface 112 near the side surface 111.

The at least one adjusting device 120 is disposed at the housing 110. Specifically, the at least one adjusting device 120 is disposed on the bottom surface 112 of the housing 110. The at least one adjusting device 120 includes a first gear 121, a stud 122, and a stopper 123. The first gear 121 has a through hole 121a. The stud 122 is engaged with the through hole 121a. The stopper 123 is fixed to the bottom surface 112 of the housing 110 by a screw 140. The stopper 123 has a limiting structure 123a and a limiting hole 123b, wherein the first gear 121 is located between the limiting hole 123b and the bottom surface 112 of the housing 110. The stud 122 penetrates the limiting hole 123b.

As described above, in this embodiment, the limiting structure 123a spans across the first gear 121, that is, a length of the limiting structure 123a is greater than a diameter of the first gear 121. Two ends of the limiting structure 123a extend toward the bottom surface 112 of the housing 110 and are fixed to the bottom surface 112 of the housing 110 by screws 140. The limiting hole 123b is disposed at a side of the limiting structure 123a. The stud 122 includes a column body 122b, wherein a side of the column body 122b has a thread 122b1, and another side of the column body 122b is provided with a stud plane 122b2. The first gear 121 is engaged with the thread 122b1 of the column body 122b. When the first gear 121 rotates, the stud 122 is driven to rotate. However, since the limiting structure 123a of the stopper 123 abuts against the stud plane 122b2, rotation of the stud 122 is limited. On the other hand, the at least one adjusting device 120 further includes a second gear 124, a third gear 125, and a knob 126. The second gear 124 is disposed on the bottom surface 112 of the housing 110 by a screw 140. The second gear 124 is rotatably disposed on the bottom surface 112 of the housing 110 and is engaged with the first gear 121. The third gear 125 is disposed on the bottom surface 112 of the housing 110 by a screw 140. The third gear 125 is engaged with the second gear 124. The knob 126 is connected to the third gear 125, wherein the knob 126 and the third gear 125 are coaxially disposed, such that the knob 126 and the third gear 125 rotate synchronously. The knob 126 is partially exposed outside the housing 110. By operation of the knob 126 by a user, the height of the projector 100 relative to a supporting surface is adjusted. The supporting surface may be a table surface or a floor surface, or any surface that supports the weight of the projector 100. In this embodiment, the first gear 121 is rotatably fixed to the bottom surface 112 of the housing 110. Further, the bottom surface 112 of the housing 110 has a fixing structure 127, and the first gear 121 is rotatably fixed to the fixing structure 127. In this embodiment, the projector 100 further has at least one foot pad 130, wherein the foot pad 130 is disposed outside the housing 110. The foot pad 130 abuts against the supporting surface. The stud 122 is connected to the foot pad 130. That is, the stud 122 penetrates the limiting hole 123b and the through hole 121a and is connected to the foot pad 130. In this embodiment, the numbers of the adjusting device 120 and the foot pad 130 are both one. In other embodiments, the numbers of the adjusting device 120 and the foot pad 130 may also be two or more. The disclosure is not limited thereto.

Continuing with reference to FIGS. 1B, 1C, 1D, and 1E, in this embodiment, the stud 122 has a fixing screw 122a and a column body 122b, wherein an end of the column body 122b is connected to the foot pad 130, and another end of the column body 122b is connected to the fixing screw 122a. The column body 122b penetrates the through hole 121a and the limiting hole 123b. In addition, the stud 122 further includes a cover 122c. The cover 122c is fixed to the column body 122b by the fixing screw 122a. A maximum length of a profile of the cover 122c is greater than a maximum length of a profile of the limiting hole 123b. The maximum length of the profile of the limiting hole 123b is greater than a maximum length of a profile of the stud 122. In this embodiment, the first gear 121 is used as a projection reference surface. An orthogonal projection of the profile of the cover 122c on the first gear 121 covers an orthogonal projection of the profile of the limiting hole 123b on the first gear 121. When the first gear 121 rotates to drive the housing 110 and the stopper 123 to move toward the direction of the fixing screw 122a, since the cover 122c is larger than the limiting hole 123b, the cover 122c can block the stopper 123 from going beyond the fixing screw 122a, so as to prevent the stopper 123 from being detached from the stud 122. On the other hand, in this embodiment, the through hole 121a of the first gear 121 has threads. The threads 122b1 of the stud 122 are engaged with the threads of the through hole 121a, such that the first gear 121 can rotate relative to the stud 122.

Referring to FIGS. 1B and 1C at the same time, when a user rotates the portion of the knob 126 exposed outside the housing 110, the knob 126 drives the third gear 125 to rotate. The third gear 125 drives the second gear 124 to rotate, and the second gear 124 drives the first gear 121 to rotate, such that the first gear 121 rotates relative to the stud 122. The first gear 121 drives the housing 110 to move up and down relative to the stud 122. In this embodiment, the first gear 121 has, for example, 60 teeth, the second gear 124 has, for example, 20 teeth, and the third gear 125 has, for example, 15 teeth. In other embodiments, the first gear 121, the second gear 124, and the third gear 125 may also have other numbers of teeth, as long as the number of teeth of the first gear 121 is greater than the number of teeth of the second gear 124 and the number of teeth of the third gear 125, and the number of teeth of the second gear 124 is greater than the number of teeth of the third gear 125. The disclosure is not limited thereto. The number of teeth of the first gear 121 is greater than the number of teeth of the third gear 125, so that a user can easily adjust the height of the projector 100 with a minimum amount of force.

As described above, in this embodiment, the limiting hole 123b of the stopper 123 is configured to solve the problem that the rotation of the first gear 121 drives the rotation of the stud 122, causing the stud 122 to tilt. Further, if the stopper 123 does not have the limiting hole 123b and only the stud plane 122b2 of the stud 122 abuts against the limiting structure 123a of the stopper 123, then when the first gear 121 rotates and drives the stud 122 to rotate, the stud 122 is prone to tilt, making it impossible to adjust the height of the projector 100. By providing the limiting hole 123b in the stopper 123, the rotational range of the stud 122 can be limited to avoid the tilting of the stud 122.

In addition, the limiting hole 123b of the stopper 123 has two grooves 123b1. The two grooves 123b1 are configured to solve the problem that the rotation of the first gear 121 drives the rotation of the stud 122, causing the thread 122b1 of the stud 122 and the limiting structure 123a of the stopper 123 to be jammed with each other. When the first gear 121 rotates and drives the stud 122 to rotate clockwise or counterclockwise, the two grooves 123b1 prevent the thread 122b1 of the stud 122 from touching the limiting structure 123a of the stopper 123. Further, the stud 122 and the stopper 123 are both made of metal material, such as aluminum. If the limiting hole 123b is not provided with the two grooves 123b1, then when the first gear 121 rotates and drives the stud 122 to rotate, the thread 122b1 of the stud 122 may be jammed by the limiting structure 123a or a tip of the thread 122b1 may be embedded into the limiting structure 123a, thereby causing the adjusting device 120 to fail to adjust the height of the projector 100. By providing the two grooves 123b1 in the limiting hole 123b, the thread 122b1 of the stud 122 can be prevented from being jammed by the limiting structure 123a, and the thread 122b1 and the limiting structure 123a can be effectively protected from damage.

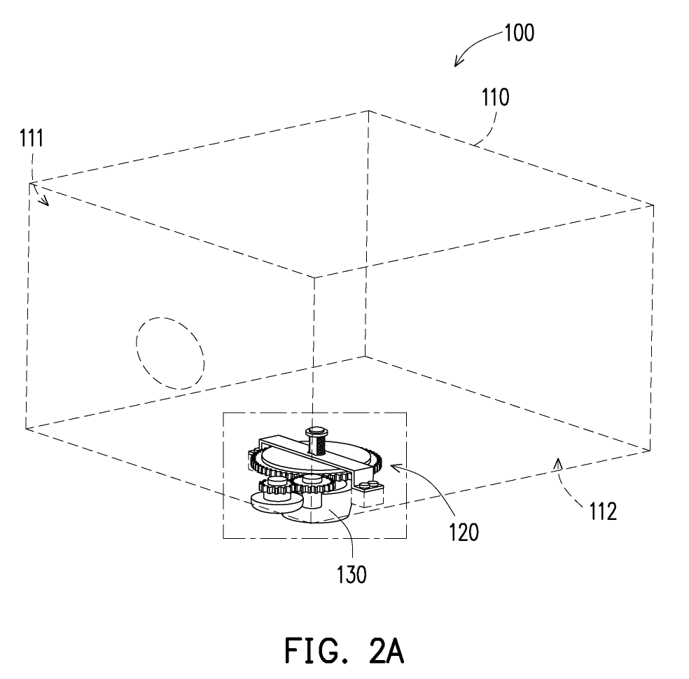

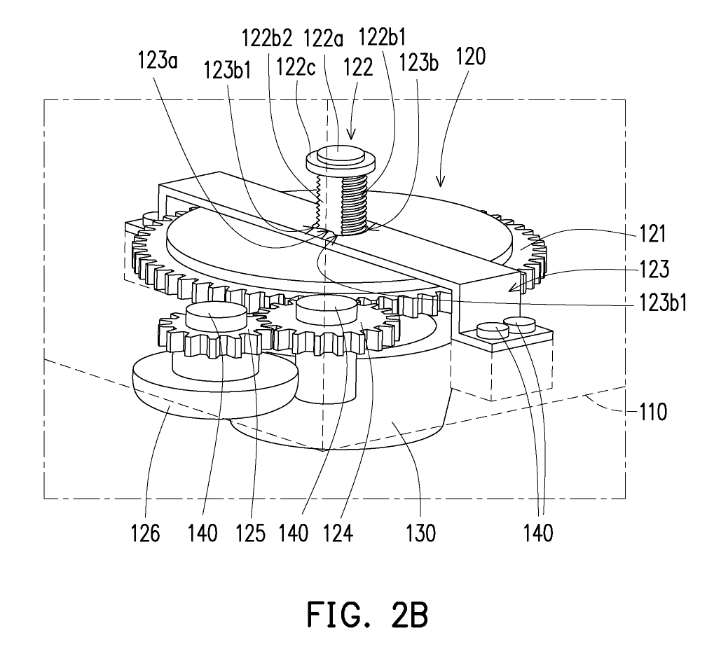

FIG. 2A is a schematic view of a projector according to another embodiment of the disclosure. FIG. 2B is a partially enlarged view of FIG. 2A. The other embodiment shown in FIG. 2A is generally the same as the embodiment in FIG. 1A. Referring to FIGS. 1B and 2B, the difference between the two is the position where the limiting hole 123b is disposed in the limiting structure 123a. That is, the limiting hole 123b is disposed in the limiting structure 123a. In detail, the limiting hole 123b is disposed at a middle position of the limiting structure 123a, which can increase the limiting strength of the stopper 123 to the stud 122, so as to reduce damage caused to both the stud 122 and the limiting hole 123b when the stud 122 rotates by the rotation of the first gear 121 and abuts against the limiting hole 123b.

In summary, the stopper of the adjusting device of the projector of the disclosure has a limiting hole, and the stud penetrates the limiting hole such that the stud is fixed in the limiting hole. Therefore, when the first gear rotates, the stud does not tilt, which would otherwise cause the adjusting device to fail to operate. In addition, the limiting hole has two grooves, such that when the stud is rotated in the limiting hole by the rotation of the first gear, the stud is not jammed in the stopper. The problem that the stud and the stopper are jammed with each other and thereby the height of the projector cannot be adjusted can be effectively solved.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projector, comprising:
a housing, comprising a bottom surface; and
at least one adjusting device, disposed in the housing, wherein the at least one adjusting device comprises:
a first gear, having a through hole;
a stud, engaged with the through hole; and
a stopper, having a limiting structure and a limiting hole, wherein the first gear is located between the limiting hole and the bottom surface, the limiting hole has two grooves, and the stud penetrates the limiting hole.

2. The projector according to claim 1, wherein two ends of the limiting structure extend toward the bottom surface and are fixed to the bottom surface.

3. The projector according to claim 1, wherein the limiting hole is disposed at a side of the limiting structure.

4. The projector according to claim 1, wherein the limiting hole is disposed in the limiting structure.

5. The projector according to claim 1, wherein the stud further comprises a column body, a side of the column body has a thread, and an other side of the column body is provided with a stud plane, the stud plane abuts against the limiting structure.

6. The projector according to claim 1, further comprising at least one foot pad, wherein an end of the stud is connected to the at least one foot pad, and the at least one foot pad is located outside the housing.

7. The projector according to claim 6, wherein the stud has a fixing screw and a column body, an end of the column body is connected to the at least one foot pad, another end of the column body is connected to the fixing screw, and the column body is engaged with the through hole.

8. The projector according to claim 7, wherein the stud further comprises a cover, and the cover is fixed to the column body by the fixing screw.

9. The projector according to claim 1, wherein the at least one adjusting device further comprises:
a second gear, disposed on the bottom surface of the housing and engaged with the first gear;
a third gear, disposed on the bottom surface of the housing and engaged with the second gear; and
a knob, connected to the third gear and partially exposed outside the housing.

10. The projector according to claim 9, wherein in response to the knob being rotated, the knob drives the third gear to rotate, the third gear drives the second gear to rotate, and the second gear drives the first gear to rotate, such that the first gear rotates relative to the stud and drives the housing to move up and down relative to the stud.

11. The projector according to claim 9, wherein a number of teeth of the first gear is greater than a number of teeth of the third gear.

12. The projector according to claim 9, wherein a number of teeth of the first gear is greater than a number of teeth of the second gear.
